(19) United States
(12) Patent Application Publication
(10) Pub. No.: US 2010/0128380 A1
(43) Pub. Date: May 27, 2010

(54) SES ASSISTED WRITE FLY HEIGHT MONITOR AND CONTROL

(76) Inventors: Yawshing Tang, Saratoga, CA (US); Carl Xiaodong Che, Saratoga, CA (US)

Correspondence Address: IRELL & MANELLA LLP, 1800 AVENUE OF THE STARS, SUITE 900, LOS ANGELES, CA, 90067, US

(21) Appl. No.: 12/323,047

(22) Filed: Nov. 25, 2008

(51) Int. Cl. G11B 21/02

(52) U.S. Cl. 360/75; G9B/21.003

(57) ABSTRACT

A hard disk drive that includes a disk, and a head that is separated from the disk by a flying height. The disk drive also includes a circuit that determines the flying height from a signal read during a write operation of the drive. The circuit performs a calibration routine to determine a temperature dependent variable of the signal to offset any temperature effects on the signal used to determine the flying height. The calibration routine can be performed using a spacing error signal (“SES”) generated by the drive.

### BACKGROUND OF THE INVENTION

1. Field of the Invention

The present invention relates to a method for determining the flying height of a head of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

HGA transducers include three primary elements: a reader sensor, a writer structure and a head protrusion control element, also known as fly-on-demand (“FOD”). The reader sensor is commonly made of an MR structure. The writer structure includes a coil and a magnetic flux path structure made with high permeability and high magnetization material. The head protrusion control element (FOD device) is typically includes a heater coil. When a current is applied, the coil generates heat and causes the writer and reader elements to move closer to the media. The FOD device is used to dynamically set writer spacing and reader spacing to the disk surface during the operation of the disk drive.

During operation, each head is separated from a corresponding disk surface by an air bearing. The air bearing eliminates mechanical interference between the head and the disks. The FOD device is used to further set reader and writer positions above the disk surface, based on a pre-calibrated target. The strength of the magnetic field from the disk is inversely proportional to the height of the reader head spacing to the disk. Reduced spacing results in a stronger magnetic field on the disk, and vice versa.

The flying height of a head may vary during the operation of the drive. For example, a shock load on the drive may create a vibration that causes the heads to mechanically resonate. The vibration causes the heads to move toward and then away from the disk surfaces in an oscillating manner. Particles or scratch ridges in the disk may also cause oscillating movement of the heads. The oscillating movement may occur in either a vertical or in-plane direction relative to the flexure arm. Environment changes, such as temperature and altitude can also cause a change in the head flying height.

If oscillation of the heads occurs during a write routine of the drive, the resultant magnetic field from the writer on the disk will vary inversely relative to the flying height of the writer. The varying magnetic field strength may result in poor writing of data. Errors may occur when the signal is read back by the drive.

Knowing and controlling the flying heights of the heads is critical for both disk drive reliability and data integrity. With the introduction of FOD technology, the disk drive can dynamically control head flying height. To accurately operate the FOD device and achieve the desirable writer and reader spacings to the disk, flying height measurement techniques have been developed. The most common technique is to use playback signal components in frequency domain.

The FOD device can be used to adjust head flying height in real time. The relative flying change for a given FOD device condition can be accurately characterized. If the head flying height relative to a desirable target can be measured, the offset can then be compensated by proper fine tuning of the FOD device setting (adjust either current or voltage). A spacing error signal (SES) of a head is defined as an indicator of a spacing offset between an actual head position and a desirable head position. The concept of SES is very similar to a position error signal (“PES”) of a disk drive servo system. One can view SES as the PES of head in the direction perpendicular to the disk surface.

There are various methods for creating spacing error signals (“SES”) that are used to control the flying height through feedback schemes. Practical construction of spacing error signals (“SES”) is limited by available electrical/mechanical signals and disk drive hardware capability. One type of SES is to use a servo automatic gain control (“AGC”) signal where a signal (AGC) embedded into a dedicated field of a servo sector is read and used to calculate SES in accordance with an AGC process. There are also schemes to utilize an AGC that reads data from a data field of the track sector. Finally, SESs can be generated by analyzing the 1st and 3rd harmonics, or ratio of harmonics, from an embedded signal(s) in a dedicated track.

Prior art schemes used to determine flying height are performed during the read operation of a drive. Errors due to excessive flying height may occur during the write process. Such errors are not identified until the written data is read back by the drive. It would be desirable to determine the flying height during a write operation of a hard disk drive.

### BRIEF SUMMARY OF THE INVENTION

A hard disk drive that includes a disk, and a head that is separated from the disk by a flying height. The disk drive also includes a circuit that determines the flying height from a signal read from the disk. The circuit performs a calibration routine to determine a temperature dependent variable of the signal.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of an electrical circuit for the hard disk drive;

FIG. 4 is a schematic showing function blocks of a read channel of the drive;

FIG. 5 is an illustration showing a track sector of a disk;

### DETAILED DESCRIPTION

Disclosed is a hard disk drive that includes a disk, and a head that is separated from the disk by a flying height. The disk drive also includes a circuit that determines the flying height from a signal read during a write operation of the drive. The circuit performs a calibration routine to determine a temperature dependent variable of the signal to offset any temperature effects on the signal used to determine the flying height. The calibration routine can be performed using a spacing error signal (“SES”) generated by the drive.

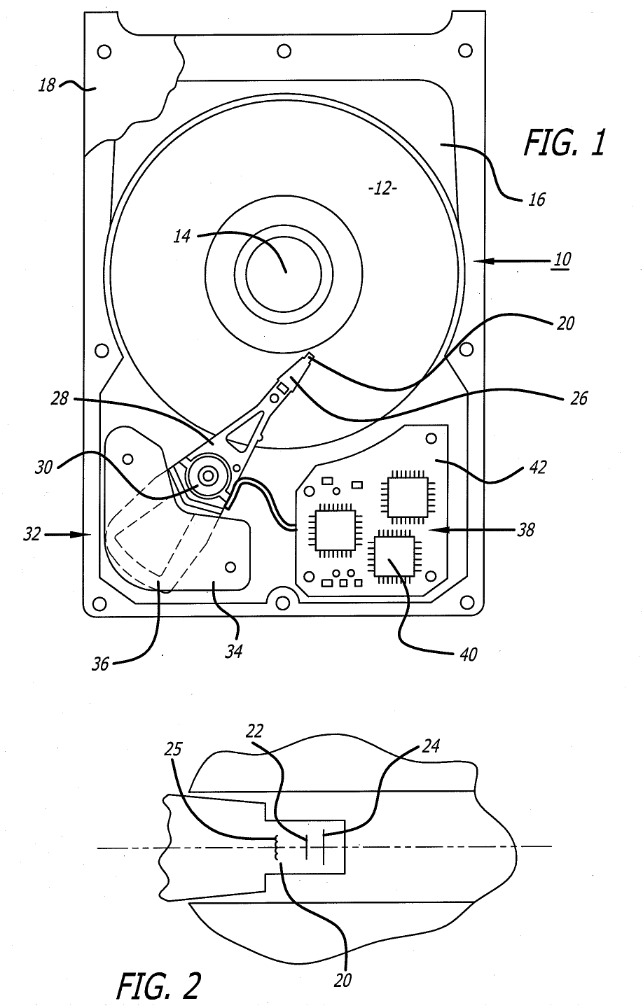

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 24 and read elements 22. The write element 24 magnetizes the disk 12 to write data. The read element 22 senses the magnetic fields of the disks 12 to read data. By way of example, the read element 22 may be constructed from a magneto-resistive material that has a resistance which varies linearly with changes in magnetic flux. The heads also contain a heater coil 25. Current can be provided to the heater coil 25 to generate heat within the head 20. The heat thermally expands the head 20 and moves the read and write elements closer to the disk.

Referring to FIG. 1, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes one or more integrated circuits 40 coupled to a printed circuit board 42. The printed circuit board 40 is coupled to the voice coil 32, heads 20 and spindle motor 14 by wires (not shown).

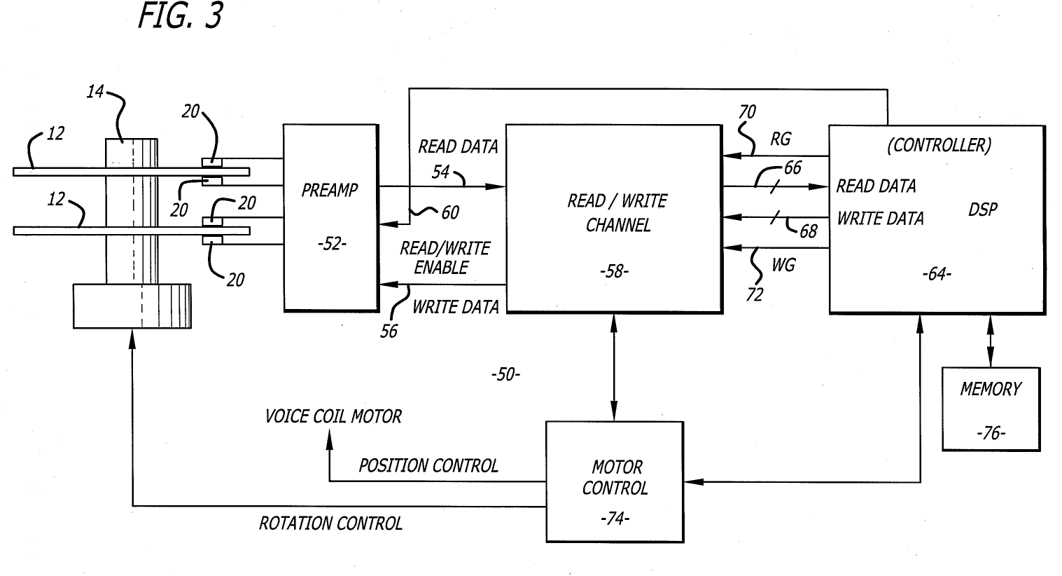

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller may have embedded firmware to operate the drive.

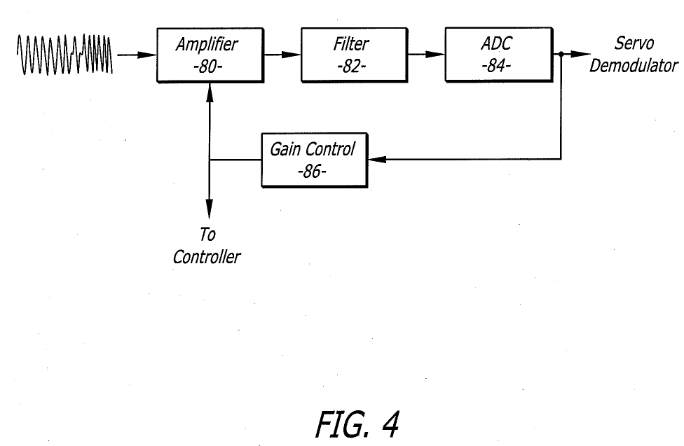

FIG. 4 is a schematic showing functional blocks of a read channel and pre-amp of the disk drive for servo signal processing. The read channel includes an amplifier 80 coupled to a head(s) (not shown). The amplifier 80 adjusts the amplitude of a signal read by the head. The amplified signal is filtered by filter 82 and converted to a digital bit string by an analog to digital (“ADC”) converter 84.

The gain of the amplifier 80 is adjusted by an automatic gain control circuit 86. The automatic gain control circuit 86 receives as input the digital output of the ADC 84 and provides an analog control signal to the amplifier 80.

The automatic gain control signal is inversely proportional to the amplitude of the read signal. A weak signal will result in a larger control signal. A larger control signal will increase the gain of the automatic gain control circuit and boost the amplitude of the read signal. The signal read by the head is inversely proportional to the head fly height. Consequently, the control signal is proportional to the flying height.

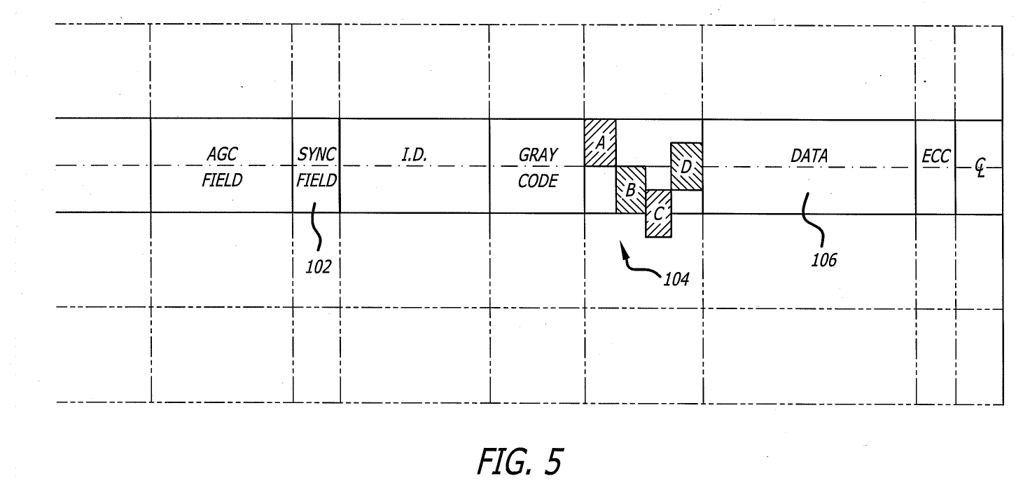

FIG. 5 is an illustration of a track sector of a disk. The sector typically includes a sync field 102 and a servo field 104 as is known in the art. The sector also has a data field 106.

A read signal generated by the sync field can be used to determine the flying height of a head. A flying height Fₛ calculated from the sync signal can be expressed as:

Fₛ=F_{ref}+Fₛₚ+Fₜ (1)

### Where;

F_{ref}=a reference spacing under specific read conditions.
Fₛₚ=the change in flying height.
Fₜ=is an error due to temperature change.

For short term changes in flying height the temperature error is non-existent because the drive temperature will not vary rapidly. Knowing the reference spacing F_{ref} and measuring the sync signal amplitude Fₛ the change in flying height Fₛₚ can be calculated from equation (1) (i.e., Fₜ=0). The reference spacing F_{ref} may change per sector. A look up table for the various sectors may be generated and called to determine the change in flying height for a specific sector. F_{ref} is a function of the magnetic properties of the read signal. Any variations due to magnetic properties can be nulled out of the F_{ref} before using it in equation (1).

The flying height can be determined during a write operation. During a write operation, the system reads the sync field and servo fields to insure that the heads are properly aligned with the disk tracks. Therefore, utilizing the sync field allows the flying height to be determined during a write operation.

Over time, the temperature error Fₜ may be introduced into the measured signal Fₛ. If the measured signal Fₛ exceeds a threshold the system may perform a calibration routine to determine the temperature error. The calibration routine may also be performed during regular time intervals, or before each write operation.

A SES signal Fₛₑₛ can be expressed as a function of Fₛ and Fₜ by the equation:

F_{SES}=F_{ref}+Fₛₚ=Fₛ−Fₜ (2)

The F_{SES} signal is obtained from a read signal during the reading of data during the calibration process. The F_{SES} can be generated in accordance with the method described in application Ser. No. ______, filed on ______, entitled Harmonic Measurement For Head-Disk Spacing Control Using User Data, which is hereby incorporated by reference. The temperature error can therefore be calculated by subtracting the SES signal Fₛₑₛ from the sync signal Fₛ. The calculated temperature error Fₜ is then used in equation (1) to determine the change in flying height Fₛₚ.

SES calibration values from other tracks can be used by utilizing a spacing profile. This may allow for a spacing profile equation that is a function of disk radius described as follows:

F(r)=Fₚ(r)+F_{c}(a)−Fₚ(a) (3)

### Where;

Fₚ(r)=the spacing profile as a function of radius.
F_{c}(a)=the SES calibration results at radius a.
Fₚ(a)=the spacing profile at radius a.
F(r)=the spacing at any radius.

Alternatively, the temperature dependent spacing change can be calculated by using the 1^{st} and 3^{rd} harmonics of a read signal and determining a temperature dependent gain G(T) with the following equation:

G(T)=\sqrt{V(f)³/V(3f)} (4)

The gain G(T) can be calculated during a read operation and during the calibration process. Once the gain G(T) is calculated the dependent spacing d can be computed from either the following 1^{st} or 3^{rd} harmonic equations:

V(f)=G(T)e^{-2λdf} (5)

V(3f)=G(T)e^{-6πdf} (6)

The spacing d can be determined during a write operation.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk;
a spindle motor that rotates said disk;
a head coupled to said disk and separated from said disk by a flying height; and,
a circuit coupled to said head, said circuit determines said flying height from a signal read from said disk, said circuit performs a calibration routine to determine a temperature dependent variable of said signal.

2. The disk drive of claim 1, wherein said flying height is determined during a write operation.

3. The disk drive of claim 1, wherein said calibration routine utilizes a space error signal.

4. The disk drive of claim 1, wherein said calibration routine utilizes a harmonic of said signal.

5. The disk drive of claim 1, wherein said disk includes a sync field and said signal is read from said sync field.

6. The disk drive of claim 1, wherein said flying height is determined using a reference flying height.

7. The disk drive of claim 1, wherein said calibration routine is performed if said signal exceeds a threshold.

8. A hard disk drive, comprising:
a disk;
a spindle motor that rotates said disk;
a head coupled to said disk and separated from said disk by a flying height; and,
circuit means for determining said flying height from a signal read from said disk including performing a calibration routine to determine a temperature dependent variable of said signal.

9. The disk drive of claim 8, wherein said flying height is determined during a write operation.

10. The disk drive of claim 8, wherein said calibration routine utilizes a space error signal.

11. The disk drive of claim 8, wherein said calibration routine utilizes a harmonic of said signal.

12. The disk drive of claim 8, wherein said disk includes a sync field and said signal is read from said sync field.

13. The disk drive of claim 8, wherein said flying height is determined using a reference flying height.

14. The disk drive of claim 8, wherein said calibration routine is performed if said signal exceeds a threshold.

15. A method for determining a flying height of a head of a hard disk drive, comprising:
determining a temperature dependent variable of a signal generated from the disk; and,
determining a flying height of a head from a read signal and the temperature dependent variable.

16. The method of claim 15, wherein the flying height is determined during a write operation.

17. The method of claim 15, wherein the calibrating step utilizes a space error signal.

18. The method of claim 15, wherein the calibrating step utilizes a harmonic of the signal.

19. The method of claim 15, wherein the signal is generated from a sync field of the disk.

20. The method of claim 15, wherein the flying height is determined using a reference flying height.

21. The method of claim 15, wherein the calibrating step is performed if the signal exceeds a threshold.
